(19) United States
(12) Patent Application Publication
(10) Pub. No.: US 2024/0160898 A1
(43) Pub. Date: May 16, 2024

(54) METHOD OF USING FPGA FOR AI INFERENCE SOFTWARE STACK ACCELERATION

(71) Applicant: EFINIX, INC., Cupertino, CA (US)

(72) Inventors: Yee Hui LEE, Bayan Lepas (MY); Ching Lun YAN, Bayan Lepas (MY)

(21) Appl. No.: 18/062,055

(22) Filed: Dec. 6, 2022

(30) Foreign Application Priority Data
Nov. 10, 2022 (MY) PI2022006334

(51) Int. Cl. G06N 3/0464; G06N 5/04

(52) U.S. Cl. CPC G06N 3/0464; G06N 5/04

(57) ABSTRACT

The present invention relates to a method of using field-programmable gate array (FPGA) for artificial intelligence (AI) inference software stack acceleration which combines the advantages of flexibility from the AI inference software stack and the programmable hardware acceleration capability of the FPGA, wherein said method comprises the steps of performing quantization on neural network (NN) model, performing layer-by-layer profiling of said NN model using AI inference software stack, identifying compute-intensive layer type of said NN model and implementing acceleration using layer accelerator on said compute-intensive layer type.

### 1. TECHNICAL FIELD OF THE INVENTION

The present invention relates to a method of using field-programmable gate array (FPGA) for artificial intelligence (AI) inference software stack acceleration which combines the advantages of flexibility from the AI inference software stack and the programmable hardware acceleration capability of the FPGA, wherein said method comprises the steps of performing quantization on neural network (NN) model, performing layer-by-layer profiling of said NN model using AI inference software stack, identifying compute-intensive layer type of said NN model and implementing acceleration using layer accelerator on said compute-intensive layer type.

### 2. BACKGROUND OF THE INVENTION

Artificial intelligence (AI), particularly neural network (NN) is gaining popularity and is widely used in various domains such as vision, audio, and time series applications. Typically, AI training is performed using central processing unit (CPU) or graphics processing unit (GPU), whereas AI inference is being deployed at the edge such as mobile GPU, microcontroller (MCU), application-specific integrated circuit (ASIC) chip, or field-programmable gate array (FPGA).

As AI inference software stack is generally used by mobile GPU and MCU, the corresponding implementations are more flexible compared to custom implementations on the ASIC chip or FPGA. Nevertheless, if the inference speed performance on a mobile GPU or MCU does not meet a particular application's requirement, no further speed performance improvements can be made to that particular GPU or MCU. In this case, a more powerful mobile GPU or MCU with higher speed performance specification is required, which would result in higher cost and higher power consumption. This implies a critical restriction especially for edge AI applications, where power usage is a key concern.

On the other hand, FPGA offers a viable platform with programmable hardware acceleration for AI inference applications. However, existing FPGA-based AI solutions are mostly implemented based on custom AI accelerator semiconductor intellectual property cores (IP cores) or parameterizable processing elements (PE), which has a predetermined support for certain AI layers/operations, specific network topologies and/or input size. If a targeted AI model contains a layer or operation that is not supported by the IP core, said AI model cannot be deployed until the IP core is updated with additional support, which may involve long design cycle and causes immerse impact on time-to-market. This poses a significant drawback as AI research is fast growing, where new model topologies/layers with better accuracy and efficiency are invented at a rapid rate.

Lee Tae Jong et al, U.S. Ser. No. 11/409,529B2, disclosed a RISC-V implemented processor with hardware acceleration supporting user defined instruction set and method thereof. However, the prior art is only for hardware acceleration which has very limited flexibility.

Jiang Yuanming et al, CN112711213A, disclosed a RISC-V kernel-based navigation acquisition and calculation Soc processing system and method thereof. However, the prior art is only for hardware acceleration which has very limited flexibility.

Hence, it would be advantageous to alleviate the shortcomings by having a method of using FPGA for AI inference software stack acceleration which combines the advantages of flexibility from the AI inference software stack and the programmable hardware acceleration capability of the FPGA.

### 3. SUMMARY OF THE INVENTION

Accordingly, it is the primary aim of the present invention to provide a method of using FPGA for AI inference software stack acceleration, which combines the advantages of flexibility from AI inference software stack and programmable hardware acceleration capability from FPGA.

It is yet another objective of the present invention to provide a method of using FPGA for AI inference software stack acceleration, which overcomes the inflexible issue embedded in existing FPGA-based AI solutions and improves the speed performance of AI inference software stack that is not achievable with mobile GPU and MCU without incurring higher cost or power usage.

Additional objects of the invention will become apparent with an understanding of the following detailed description of the invention or upon employment of the invention in actual practice.

According to the preferred embodiment of the present invention the following is provided:

A method of using field-programmable gate array (FPGA) for artificial intelligence (AI) inference software stack acceleration, comprising the following steps:
i. performing quantization on at least one neural network model;
ii. performing layer-by-layer profiling of said neural network model using AI inference software stack;
iii. identifying at least one compute-intensive layer type of said neural network model;
iv. implementing acceleration using at least one layer accelerator on at least one of said compute-intensive layer type.

### 4. BRIEF DESCRIPTION OF THE DRAWINGS

Other aspect of the present invention and their advantages will be discerned after studying the Detailed Description in conjunction with the accompanying drawings in which:

FIG. 1 is a flowchart showing the first embodiment of the present invention.

FIG. 2 is a flowchart showing the second embodiment of the present invention.

FIG. 3A is a flowchart showing an example of the layers in a neural network model prior to acceleration and FIG. 3B is a flowchart showing said layers being accelerated by either library accelerator or custom accelerator.

### 5. DETAILED DESCRIPTION OF THE DRAWINGS

In the following detailed description, numerous specific details are set forth in order to provide a thorough understanding of the invention. However, it will be understood by the person having ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings, which are not drawn to scale.

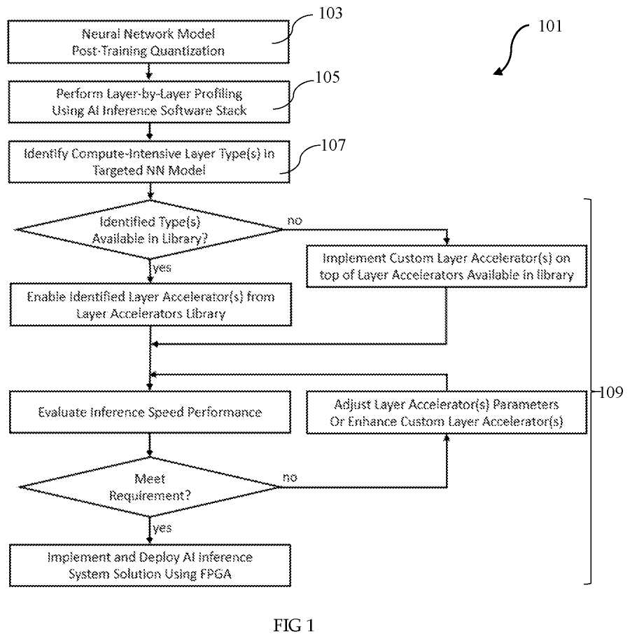

The invention presents a method of using FPGA for AI inference software stack acceleration, said method illustrated in FIG. 1. To get started, users may train their own neural network model or make use of at least one pre-trained neural network model available publicly in any suitable repository such as online Model Zoo, TensorFlow, PyTorch Hub, etc. Examples of neural network models are classification models (for classification of items), detection models (for detecting presence of items), prediction models (for predicting future trends based on previous data), image super resolution models, image segmentation models, etc. Neural network models such as convolutional neural network (CNN) comprises of multiple layers such as convolution layer, pooling layer, fully connected layers, etc.

The method of the present invention (101) begins with step (i) of performing quantization on at least one neural network model (103). Generally, neural network models comprise of activation nodes, connection between nodes and weight parameter related to said connection. The unquantized weight parameters are usually in floating-point value which requires a larger number of bits to represent said value. The quantization is meant to convert the neural network model with weight parameters of floating-point values, to weight parameters of full integer values, which in turn requires a lower number of bits to represent said value. Quantization can also be done on the inputs, biases, activations, etc. For example, the quantization can be done using the TensorFlow Lite converter, which converts the TensorFlow neural network model to TensorFlow Lite model. If the neural network model is trained with a different training framework such as Pytorch (not Tensorflow), Tensorflow Lite converter can also be used to perform the quantization. There are Python function/API to facilitate the conversion between different saved model format from various training frameworks. Quantization can be done post-training or via quantization aware training. Post-training quantization refers to a process of performing quantization on a trained neural network model. Quantization aware training emulates inference-time quantization, which models quantization errors in forward and backward passes. During quantization aware training, forward propagation is based on integers (which is low precision behavior) while back propagation is based on floating points. Model quantization is important to ensure efficient neural network model inference, especially for edge AI solutions, because it can reduce the neural network model's size, improve the CPU and/or hardware accelerator latency and be more power efficient.

Generally, neural network model or topologies are designed and built based on different types of neural network layers. Examples of neural network layers are convolution layer, depthwise convolution layer, pooling layer, fully connected layer or any other suitable layer in said neural network model. In step (ii), at least one embedded processor such as RISC-V in at least one FPGA performs layer-by-layer profiling of the quantized neural network model using targeted AI inference software stack (105), whereby a user initially identifies one suitable AI inference software stack to start with. For example, the TF Lite Micro C++ library or any other suitable AI inference software stack can be run on said embedded processor to start said layer-by-layer profiling. Layer-by-layer profiling records the execution time of each individual layer of said neural network model. The recording of said execution time can be done by making use of the timestamp function or application programming interface (API) supported by the embedded processor or the AI inference software stack. Said profiling also records the type of each individual layer of said neural network model. Typical types of layers can be convolution layer, depthwise convolution layer, fully connected layer or any other suitable layer types. An AI neural network model may comprise of one or more types of layers. The profiling result is important for analyzing the overall inference performance based on the break-down of each neural network layer. The execution time obtained from said profiling step, can then be printed or shown on a terminal for further analysis.

Based on the layer-by-layer profiling result, in step (iii), at least one user identifies and sorts out at least one compute-intensive layer type of said neural network model that majorly contributes to the overall inference time (107). The decision on how many or which of the most compute-intensive layer type(s) to be chosen for acceleration depends on the performance requirement of the targeted AI inference application as well as the available logic resources on the FPGA. This is generally considered as a performance-resource tradeoff.

Based on the identified or chosen layer type(s) for acceleration, step (iv) in the method of the present invention suggests that at least one user implements or enables acceleration using at least one layer accelerator on at least one of said compute-intensive layer type (109).

In the first embodiment of step (iv) in the method of the present invention, as shown in FIG. 1, the particular layer type's accelerator is cross-checked whether it is available in at least one layer accelerators library provided by the platform developer. If said particular layer type's accelerator is not available in said layer accelerator library, the user may design and/or implement their own custom layer accelerator accordingly, which would involve additional design effort. If said particular layer type is available in the layer accelerators library, the user can implement or use the layer accelerators available in said layer accelerators library and enabling said layer accelerators as required. Said layer accelerator can be custom layer accelerator layer accelerator from at least one layer accelerators library or combination thereof.

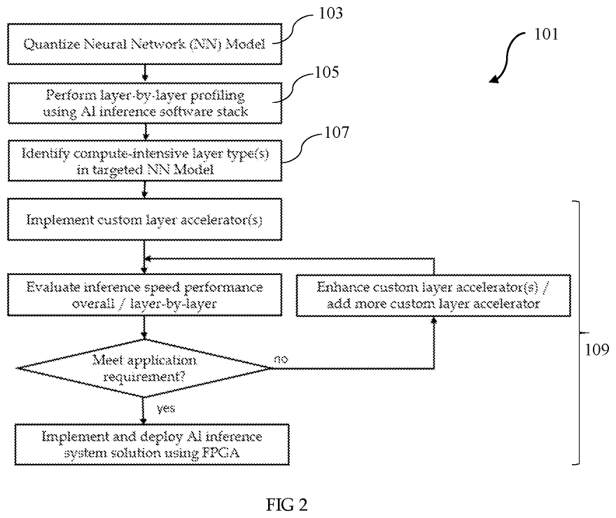

In the second embodiment of step (iv) in the method of the present invention, as illustrated in FIG. 2, step (iv) is done using only at least one custom layer accelerator instead of cross-checking with the layer accelerators library.

After enabling at least one layer accelerator from said layer accelerator library and/or user custom layer accelerator(s), said embedded processor in said FPGA records the AI inference's speed performance to be evaluated. The recording can be done on either the overall AI inference's speed performance, or the speed performance of the layers in said AI inference. Notably, the overall AI inference's speed performance recording is preferred over the layer-by-layer AI inference's speed performance recording, because said overall AI inference's speed performance will provide the user or designer with a more accurate indication whether the targeted inference speed requirement meets the specific intended application, or more acceleration is required. It is also possible to record both the overall and layer-by-layer AI inference's speed performance, so that the overall speed performance and layer-by-layer speed performance can be evaluated according to the needs. The evaluation can be done by at least one user or automatically evaluated by said embedded processor in said FPGA. If the overall AI inference's speed performance meets the requirement of at least one intended targeted application (particularly edge AI application), the user may proceed to implement and deploy said accelerated AI inference system solution by integrating required sensor(s), input/output (I/O) transfer mechanism, and other essential elements to form a complete system on said FPGA with the previously accelerated inference implementation that is incorporated with the AI inference software stack. Examples of said targeted applications can be edge AI, general AI inference application or any other suitable AI inference applications.

On the other hand, if the overall inference speed performance after initial acceleration does not meet the requirement of said application(s), the user may re-iterate the process by adjusting at least one parameter of the enabled layer accelerator(s), enhancing at least one user-implemented custom layer accelerator, adding more custom layer acceleration, or combination thereof before performing step (ii) again. Examples of said parameter are convolution accelerator input parallelism, output parallelism or combination thereof. In order to identify which neural network layer type(s) requires further acceleration, the user may perform layer-by-layer profiling again (step (ii) of the present invention) at this stage, to identify the updated compute-intensive or time-consuming layer type(s) after the initial acceleration.

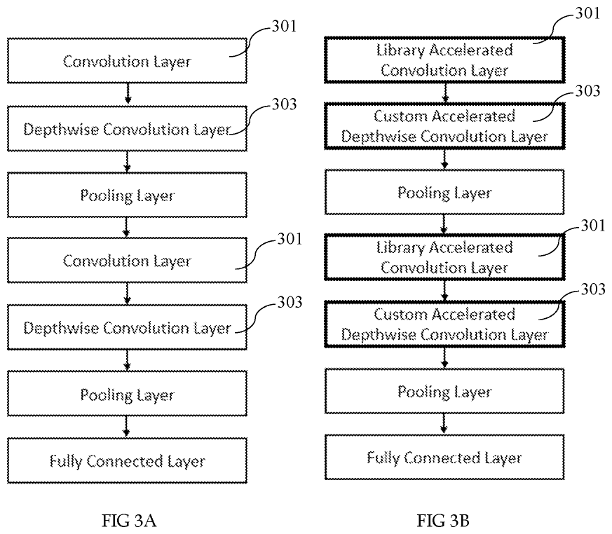

To further demonstrate the proposed method of the present invention, FIG. 3A depicts an example of a convolutional neural network (CNN) model. Assuming that after post-training quantization (step (i)) and layer-by-layer profiling (step (ii)) are performed on the CNN model, two convolution layers (301) and two depthwise convolution layers (303) are identified as the most compute-intensive layer types for this neural network model. In addition, for this example it is found that the convolution layer (301) accelerator in available in the layer accelerators library, whereas depthwise convolution layer (303) accelerator is not available in said layer accelerators library.

In this case, as presented in the method of the present invention, the user may implement a self-designed custom layer accelerator for depthwise convolution and enable the convolution layer accelerator in the layer accelerators library accordingly, as illustrated in FIG. 3B. If after the initial acceleration (step (iv)) and another round of layer-by-layer profiling analysis, the convolution layers (301) are still identified as the bottleneck of the overall inference time, the various combinations of the library parameters of convolution layer (301) accelerator may be explored to meet the targeted application requirement. If after the initial acceleration (step (iv) and another round of layer-by-layer profiling analysis, the depthwise convolutions (303) are still identified as the bottleneck of the overall inference time, further enhancement needs to be made to said custom layer accelerator.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

What is claimed is:

1. A method of using field-programmable gate array (FPGA) for artificial intelligence (AI) inference software stack acceleration (101), comprising the following steps:
i. performing quantization on at least one neural network model (103);
ii. performing layer-by-layer profiling of said neural network model using AI inference software stack (105);
iii. identifying at least one compute-intensive layer type of said neural network model (107);
iv. implementing acceleration using at least one layer accelerator on at least one of said compute-intensive layer type (109).

2. The method of using FPGA for AI inference software stack acceleration as claimed in claim 1, wherein said layer accelerator is custom layer accelerator, layer accelerator from at least one layer accelerators library or combination thereof.

3. The method of using FPGA for AI inference software stack acceleration as claimed in claim 2, further comprising the following steps after step (iv):
v. recording said AI inference's speed performance to be evaluated;
vi. implementing said accelerated AI inference on at least one FPGA if said AI inference's speed performance meets at least one application's requirement; or enhancing at least one custom layer accelerator, adding more custom layer acceleration, adjusting said layer accelerator's at least one parameter or combination thereof before performing step (ii) again if said AI inference's speed performing does not meet said application's requirement.

4. The method of using FPGA for AI inference software stack acceleration as claimed in claim 1, wherein said quantization is done post-training or via quantization aware training.

5. The method of using FPGA for AI inference software stack acceleration as claimed in claim 1, wherein said performing quantization is converting floating-point neural network model to full integer quantized neural network model.

6. The method of using FPGA for AI inference software stack acceleration as claimed in claim 1, wherein said layer is convolution layer, depthwise convolution layer, pooling layer, fully connected layer or any other suitable layer in said neural network model.

7. The method of using FPGA for AI inference software stack acceleration as claimed in claim 3, wherein said parameter is convolution accelerator input parallelism, output parallelism or combination thereof.

8. The method of using FPGA for AI inference software stack acceleration as claimed in claim 3, wherein said application is edge AI, general AI inference application or any other suitable AI inference applications.

9. The method of using FPGA for AI inference software stack acceleration as claimed in claim 3, wherein said AI inference's speed performance comprises of an overall AI inference's speed performance, layer-by-layer AI inference's speed performance or combination thereof.
